(19) United States
(12) Patent Application Publication
(10) Pub. No.: US 2025/0292016 A1
(43) Pub. Date: Sep. 18, 2025

(54) Filtering Content for Automated User Interactions Using Language Models

(71) Applicant: PlanetArt, LLC, Calabasas, CA (US)

(72) Inventor: Erik Malkemus, Reseda, CA (US)

(21) Appl. No.: 18/606,758

(22) Filed: Mar. 15, 2024

(51) Int. Cl. G06F 40/20; H04L 51/02

(52) U.S. Cl. CPC G06F 40/20; H04L 51/02

(57) ABSTRACT

Methods, apparatus, and processor-readable storage media for filtering content for automated user interactions using language models are provided herein. An example method includes obtaining a plurality of portions of content based on a query corresponding to one or more topics related to an organization, where the plurality of portions of content is retrieved from at least one content source corresponding to the organization, and configuring a first language model instance to generate a score for each portion of content in the plurality of portions of content based on its relevancy to the query. The method includes filtering the plurality of portions of content based at least in part on one or more filtering criteria and the score generated for each portion, and generating, using a second language model instance, a response to the query, where the response is based on the portions of content resulting from the filtering.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates generally to artificial intelligence, and, more specifically, to using language models in customer service interactions. Organizations are increasingly relying on tools, such as chatbots, to assist with customer service interactions. Chatbots generally refer to software programs that are designed to simulate conversations with human users. For example, chatbots can be programmed to answer frequently asked questions, to troubleshoot common problems, and/or to provide information about products or services.

### SUMMARY

Illustrative embodiments of the disclosure provide techniques for filtering content for automated user interactions using language models. An exemplary computer-implemented method includes obtaining a plurality of portions of content based on a user query corresponding to one or more topics related to an organization, wherein the plurality of portions of content is retrieved from at least one content source corresponding to the organization; configuring a first language model instance to generate a score for each portion of content in the plurality of portions of content based on its relevancy to the user query; filtering the plurality of portions of content based at least in part on one or more filtering criteria and the score generated for each portion; and generating, using a second language model instance, a response to the user query, wherein the response is based at least in part on the portions of content resulting from the filtering.

Illustrative embodiments can provide significant advantages relative to conventional automated user interaction techniques. For example, technical problems associated with providing accurate and relevant answers to users are mitigated in one or more embodiments by utilizing multiple large language models to efficiently filter content associated with one or more topics and generate a response to a user query.

These and other illustrative embodiments described herein include, without limitation, methods, apparatus, systems, and computer program products comprising processor-readable storage media.

### BRIEF DESCRIPTION OF THE DRAWINGS

FIG. 1 is a block diagram of one possible and non-limiting exemplary system in which the exemplary embodiments may be practiced.

FIG. 2 is a system architecture for filtering content using language models in an illustrative embodiment.

FIG. 3 is an example of a process flow diagram for processing and responding to user queries in accordance with an illustrative embodiment.

FIG. 4 is an example of a client user interface in accordance with an illustrative embodiment.

FIG. 5 is a logic flow diagram of a process for filtering content for automated user interactions using language models according to an illustrative embodiment.

### DETAILED DESCRIPTION

The exemplary embodiments herein describe techniques for filtering content for automated user interactions using language models. Additional description of these techniques is presented after a system into which the exemplary embodiments may be used is described.

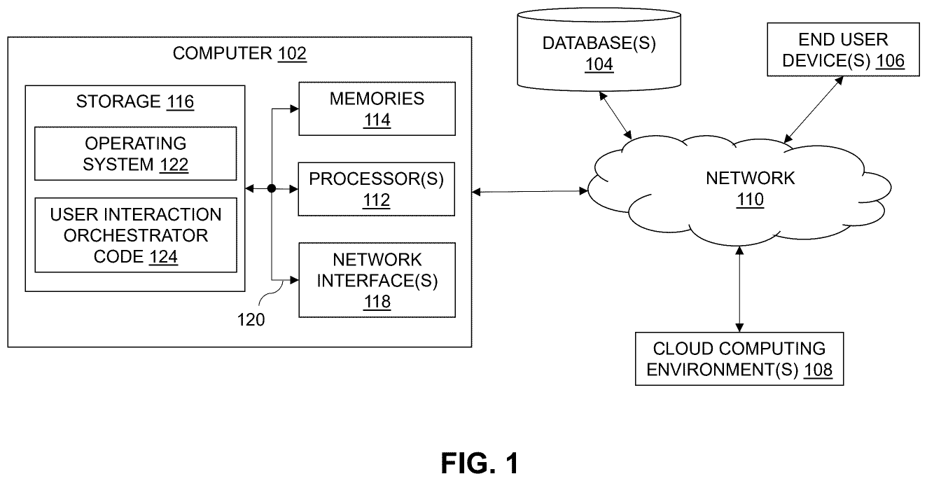

FIG. 1 shows a block diagram of one possible and non-limiting example of a computing environment in which the exemplary embodiments may be practiced. For example, the computing environment depicted in FIG. 1 can be used for executing at least some of the computer code associated with one or more exemplary processes described herein, such as user interaction orchestrator code 124.

The computing environment in FIG. 1 includes, for example, a computer 102, one or more databases 104, one or more end user devices 106, one or more cloud computing environments 108, and a network 110 (e.g., a wide area network (WAN)). In this context and elsewhere herein, the term “user” is intended to be broadly construed so as to encompass, for example, human, hardware, software, or firmware entities, as well as various combinations of such entities.

The computer 102 includes one or more processors 112, one or more memories 114, storage 116, and one or more network interfaces 118, interconnected through one or more buses 120.

In some embodiments, the computer 102 can be implemented as, for example, a desktop computer, laptop computer, tablet computer, server or other type of computer or device that is capable of, for example, executing one or more applications, accessing one or more networks, and/or communicating with one or more databases, such as databases 104.

Although some embodiments are described herein with reference to a single computer (e.g., computer 102), this is not intended to be limiting and other implementations are also possible. For example, in at least some embodiments, performance of one or more computer-implemented processes described herein can be distributed among multiple computers, possibly distributed across multiple locations. As another example, computer 102 may be implemented at least partially within a cloud environment, such as the one or more cloud computing environments 108.

The one or more processors 112 can include, for example, one or more central processing units (CPUs), one or more graphics processing unit (GPUs), one or more application-specific integrated circuits (ASICs), one or more microprocessors, one or more microcontrollers, and/or other types of processing circuitry. Also, one or more of the processors 112 can include multiple processor cores, multiple processor threads, and/or be distributed across multiple packages. At least some of the processors 112 may implement one or more cache memories (not explicitly shown in FIG. 1).

The one or more memories 114 can include, for example, volatile memory, such as static random-access memory (SRAM), dynamic random-access memory (DRAM), and/or other types of random-access memory (RAM).

In some embodiments, storage 116 can include non-volatile storage (such as read-only memory (ROM)) and possibly other types of memory (e.g., memory that enables data to be written and/or deleted). Non-limiting examples of storage 116 include hard disk drives (HDDs), solid-state drives (SSDs), optical media, and magnetic disks.

In the FIG. 1 example, storage 116 includes an operating system (OS) 122. The OS 122 can correspond to a propriety OS or a commercially available OS, as non-limiting examples. In some embodiments, the OS 122 can include a kernel, a process manager, memory manager, a file system, device drivers, and/or other types of services or components related to operating the computer 102 (e.g., one or more user interfaces, a network stack and/or security-related services).

Generally, the one or more network interfaces 118 can be implemented as software, hardware, and/or firmware components, for enabling the computer 102 to communicate over the network 110 with the one or more databases 104, the one or more end user devices 106, the one or more cloud computing environments 108, and/or other systems or devices not explicitly shown in FIG. 1. For example, the one or more network interfaces 118 can comprise one or more modems and/or one or more transceivers, such as a Wi-Fi transceiver.

The one or more buses 120 may be, for example, address, data, and/or control buses, and may include any interconnection mechanism, such as a series of lines on a motherboard or integrated circuit, fiber optics or other optical communication equipment, and/or other types of interconnection mechanisms.

The one or more databases 104 shown in FIG. 1 can be implemented using one or more storage systems. Such storage systems can include, for example, network-attached storage (NAS), storage area networks (SANs), direct-attached storage (DAS), and distributed DAS, and/or software-defined storage, as well as combinations of these and other storage types.

A given one of the end user devices 106 can be implemented in an equivalent manner as discussed above in conjunction with the computer 102. In some embodiments, the given end user device 106 can be used by one or more end users, such as a customer or a user associated with an entity associated with computer 102. For example, in some embodiments, the given end user device 106 can interact with a customer service chatbot instance that is executing at least in part by computer 102. For example, the customer service chatbot instance can communicate data to the given end user device 106 about a topic (e.g., product and/or a service) related to an organization, as described in more detail elsewhere herein.

In the example shown in FIG. 1, the network 110 is assumed to correspond to a wide area network (WAN), such as the Internet. Alternatively, or additionally, the network 110 can comprise a local area network (LAN), a satellite network, a telephone or cable network, a cellular network, a wireless network (e.g., a Wi-Fi or WiMAX network), or various portions or combinations of these and other types of networks. Generally, such networks implement hardware and/or components to enable data to be communicated, including, for example, cables, routers, firewalls, switches, gateways, and/or servers.

The one or more cloud computing environments 108 may include, for example, one or more public cloud computing environments, one or more private cloud computing environments, and/or one or more hybrid cloud computing environments. For example, a given cloud computing environment 108 can provide on-demand computing resources. Typically, the computing resources provided by a cloud computing environment are implemented using one or more virtualized computing environments.

A virtual computing environment can include physical hardware (e.g., one or more servers, one or more computers, and/or other types of computing devices) that implement one or more types of virtualized infrastructure, such as one or more virtual machines (VMs) and/or one or more containers. For example, a virtual computing environment may include software in the form of one or more hypervisors that manage one or more VMs running on the physical hardware. VMs generally refer to software representations of physical computers. VMs enable multiple OSs to run on a single physical host, where each VM can have its own set of virtual computing resources (e.g., CPU, memory, storage, and network resources).

Alternatively, or additionally, the virtual computing environment may include a plurality of containers implemented using one or more host devices. For examples containers can be stored as images that include the application code, dependencies, and configuration files that are used to run the container. A container runtime generally is used to manage the lifecycle of containers by creating, starting, stopping, and/or destroying containers. The container runtime also manages how resources are shared between such containers. An orchestration platform can be implemented to manage the deployment, scaling, and scheduling of containers. Containers are capable of running on any system regardless of the computing infrastructure and/or operating system.

It is to be understood that the particular set of elements shown in FIG. 1 is presented by way of illustrative example only, and in other embodiments additional or alternative elements may be used. Thus, another embodiment can include additional or alternative systems, devices and other network entities, as well as different arrangements of modules and other components. For example, in at least one embodiment, one or more of: the computer 102, at least one of the databases 104, at least one of the cloud computing environments 108, and/or portions of such elements can be on and/or part of the same processing platform.

Having thus introduced one suitable but non-limiting technical context in which the exemplary embodiments described herein may be practiced, the exemplary embodiments will now be described with greater specificity.

As noted herein, organizations and e-commerce platforms often prioritize delivering fast, accurate, and relevant information to their customers, and the rise of AI-powered chatbots has played a pivotal role in automating and enhancing such interactions. For example, chatbots can serve as virtual assistants that guide users through product inquiries, service-related questions, and/or order status updates.

Conventional chatbot techniques often rely on vector databases and/or semantic search processes to identify one or more articles that are similar to a user query. Although such techniques generally are capable of identifying a broad set of potentially relevant articles, they often fail to identify content that adequately addresses the user's query. Such situations negatively affect the user experience and/or require a human customer agent to intervene.

Other techniques to address technical challenges for improving the relevancy and quality of information provided by chatbots often rely on predefined scripts and/or rule-based systems to respond to queries. However, such techniques often do not understand the nuances of user queries or retrieve the most pertinent data from vast knowledgebases (KBs). More advanced systems integrate or utilize language models to enable more natural and intelligent interactions. However, even in these more advanced systems there is no mechanism for filtering and refining information available in KBs to ensure that relevant articles and/or data are provided to the chatbot and, by extension, to the user.

Some embodiments described herein can include utilizing respective instances of at least two different language models to retrieve, filter, and present content (e.g., such as articles from a KB) to one or more users as part of an automated customer service interaction. For example, the content can be presented based on one or more user queries pertaining to one or more topics. In at least some embodiments, the content can be used as part of an automated conversation between a human and a machine (e.g., a chatbot). Such embodiments can help enhance the accuracy and relevancy of information provided to the user, thereby providing a seamless and informed user experience with the chatbot. The application of multiple language models can help reduce the number of resources (e.g., computing resources) needed for processing such queries, as explained in more detail elsewhere herein.

The term “language model” in this context and elsewhere herein is intended to be broadly construed so as to encompass, for example, natural language processing models that are trained on massive amounts (e.g., possibly hundreds of gigabytes or more) of data to understand, summarize, generate and/or predict new content. Such language models are also commonly referred to as large language models. Language models often are implemented using transformer-based architectures. Transformer-based architectures can process input through a sequence of transformers, where each transformer includes a self-attention layer and feedforward layer. The self-attention layer computes an importance of each token in a sequence of input tokens, and the feedforward layer transforms the output of the self-attention layer into a form that is suitable for the next transformer in the sequence. It is noted that this is merely one example of a language model architecture and other architectures can also be used, such as Long Short-Term Memory (LSTM) architectures.

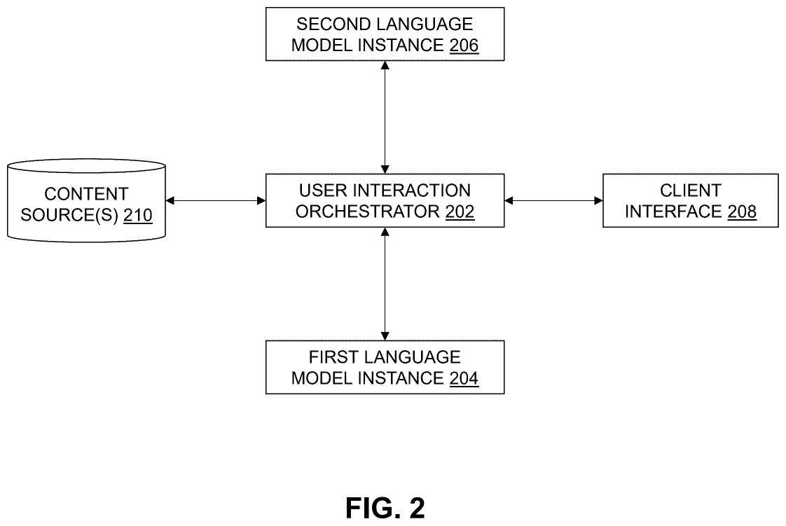

FIG. 2 shows a system architecture for a chatbot in accordance with an illustrative embodiment. The example in FIG. 2 includes a user interaction orchestrator 202, a first language model instance 204, a second language model instance 206, a client interface 208, and one or more content sources 210. As non-limiting examples, the first language model instance 204 may correspond to a GPT-3.5-turbo instance, and the second language model instance 206 may correspond to a GPT-4 instance. It is noted that the term ‘instance’ as used in the context of language models and elsewhere herein refers to a particular configuration for processing of at least one query and/or at least one task. In some examples, an instance of a given language model can include a specific input context provided by system messages, other message inputs, a selection of settings (e.g., selection of one or more hyperparameters such as temperature and top-p), and/or a particular model version. A given instance can operate within its designated context, serving at least one distinct function (e.g., evaluating and/or rescoring articles or facilitating a conversation with a user).

According to some embodiments, the elements shown in FIG. 2 can be implemented by the system in FIG. 1. As a non-limiting example, the user interaction orchestrator 202 can be implemented at least in part using user interaction orchestrator code 124, the first language model instance 204 and the second language model instance 206 can be implemented by computer 102 and/or one or more of the cloud computing environments 108, the client interface 208 can be implemented by a given on of the end user devices 106, and the one or more content sources 210 can be implemented by at least one of the databases 104. Generally, the user interaction orchestrator 202 utilizes the first language model instance 204 and the second language model instance 206 to process and respond to one or more queries via the client interface 208, based at least in part on content stored in the one or more content sources 210. Accordingly, the client interface 208 can serve as the primary interaction point used by end users to initiate conversations, ask questions, and receive answers, for example.

In response to receiving a user query, the user interaction orchestrator 202 can retrieve content (e.g., articles) from the at least one of the content sources 210. For example, the one or more content sources 210 can include at least one KB comprising content related to various topics (e.g., an organization's products and/or services, general information about the organization, and/or other relevant information). In some embodiments, the user interaction orchestrator 202 can retrieve the content by performing a vector similarity search based on the user query. As an example, the vector similarity search can retrieve content. In some embodiments, the retrieved content can be formatted in a structured data object (such as a JSON object), where each article is assigned a unique identifier (ID) for purposes of tracking and evaluating.

The user interaction orchestrator 202 can provide the structured data object to the first language model instance 204 alongside a system prompt or message. For example, the system prompt can instruct the first language model instance 204 to evaluate and score each of the articles based on its relevance to the original user query. The first language model instance 204 can be configured to ensure that the scoring goes beyond basic semantic similarity, and can thus consider nuances, contextual relevance, as well as the quality and comprehensiveness of the content being evaluated. For example, the scores can be provided for each unique identifier in the structured data object.

The user interaction orchestrator 202 can obtain the scores from the first language model instance 204 and apply one or more filtering criteria. For example, the one or more filtering criteria may include retaining content that satisfies a threshold score and/or retaining a specified number of articles having the highest scores (e.g., the four articles with the highest scores).

The user interaction orchestrator 202 provides the filtered content to the second language model instance 206 to generate a response to the user query, which is provided to the user via the client interface 208.

The second language model instance 206 is assumed to use the filtered content as reference material, as opposed to providing the full content to the user.

In some embodiments, the second language model instance 206 may be more complex than the first language model instance 204. For example, the second language model instance 206 may include more advanced features than the first language model instance 204 (such as allowing larger input sizes and/or capability to generate accurate and contextually coherent responses). Also, the second language model instance 206 may have a larger number of model parameters and/or utilize more computing resources (e.g., processing, memory, and/or network). Thus, at least some embodiments can efficiently utilize the first language model instance 204 to score the content and can generate coherent and accurate responses using the more complex second language model instance 206.

In at least some embodiments, the first language model instance 204 and the second language model instance 206 may use different values for a hyperparameter that controls a randomness of generated output. Such a hyperparameter is commonly referred to as a temperature hyperparameter. More specifically, consider a large language model that generates text by selecting one word (or token) at a time. For example, the large language model can calculate probabilities for each potential next word based on the input that the large language model has already processed and its internal parameters or weights. Words with higher probabilities are generally more likely to be chosen. Changing the value of the “temperature” hyperparameter can influence a randomness or certainty of which word is selected. As a non-limiting example, increasing the temperature hyperparameter value can flatten or widen the probability distribution that is used to select the next word, thereby increasing the randomness of the text generated by the language model. Decreasing the temperature hyperparameter value can sharpen or narrow the probability distribution so that the language model focuses on the most likely words, thereby leading to a more predictable output.

In at least some embodiments, the value of the temperature hyperparameter for the first language model instance 204 can be set to a relatively lower value than the second language model instance 206. Such embodiments allow the first language model instance 204 to provide more deterministic outcomes for generating scores for text (e.g., articles). The second language model instance 206 can respond more creatively (e.g., different phrasing), which can provide a more natural style of interaction.

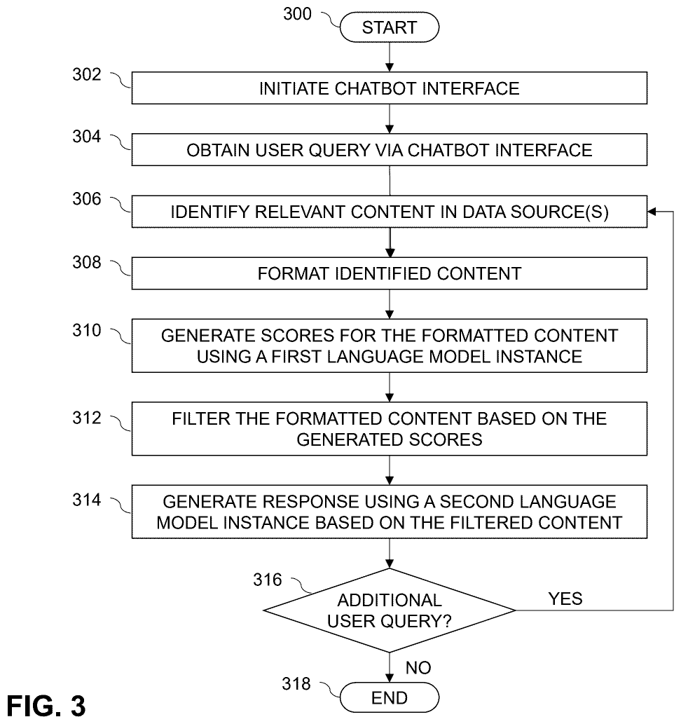

FIG. 3 is an example of a process flow diagram for processing and responding to user queries in accordance with an illustrative embodiment. FIG. 3 can illustrate the operation of exemplary methods, the execution of computer program instructions embodied on computer-readable memory, the execution of functions performed by logic implemented in hardware, and/or interconnected means for performing functions in accordance with exemplary embodiments. In this embodiment, the process includes steps 300 through 318, which can be performed at least in part by the user interaction orchestrator 202 and/or the computer 102.

The process starts at step 300. Step 302 includes initiating a chatbot interface. For example, the chatbot interface can be implemented in response to a user request.

Step 304 includes obtaining a user query via the chatbot interface. For example, the user query can be related to one or more topics.

Step 306 includes identifying relevant content in one or more data sources. As an example, the one or more data sources can be maintained by an organization and can comprise one or more articles related to products and/or services provided by the organization. The relevant content can be identified by performing a vector similarity search, such as described in conjunction with FIG. 2, for example.

Step 308 includes formatting the identified content. For example, the retrieved articles can be formatted into a structured JSON object, where each article is assigned a unique ID.

Step 310 includes generating scores for the formatted content using a first language model. For example, the scores can be generated for each unique ID in the structured JSON object. In some embodiments, the first language model instance can be configured using a prompt to evaluate and score the content associated with each unique ID based on its relevance to the user query obtained in step 304.

Step 312 includes filtering the formatted content based on the scores. For example, step 312 can include applying the one or more filtering criteria, such as retaining content that satisfies a threshold score and/or retaining a specified number of articles having the highest scores.

Step 314 includes generating a response to the user query using a second language model instance based on the filtered content. For example, the second language model instance can generate the response in response to being provided the original user query as well as the filtered content as input.

Step 316 includes a test that checks whether the user has provided an additional user query. If yes, the process returns to step 306 to process the additional user query. Otherwise, the process ends at step 318.

In some embodiments, the process depicted in FIG. 3 may optionally include a step of determining an intent or topic related to the user query obtained at step 304, for example, by processing the user query with the second language model instance. If it is determined that the user query relates to a topic not covered by the one or more data sources, then another tool can be invoked to respond to the user query. As a non-limiting example, if the user query relates to a status of a specific order, then the process can call a system or tool that maintains order information to obtain the status of that order. In such an example, if the user query relates to a product, service, or general information, then the process can proceed with steps 306-314 as described above.

It is to be understood that the process depicted in FIG. 3 is only an example, and additional or alternative processes can be carried out in other embodiments.

As noted above, a first language model instance can be configured using a prompt to evaluate and score the content, and a second language model instance can also be configured to provide responses to the user query according to the organization's priorities or goals. For example, the second language model instance can also be provided with a prompt message specifying one or more rules. Non-limiting examples of such rules can indicate at least one of: status updates to customers should not be provided unless the status is checked using a status tool first; questions should not be answered about products, services, policies, website or contact information without first accessing one or more KBs specific to the organization; and a customer should be offered to transfer to a human customer agent if an acceptable answer cannot be generated. The second language model instance can also be provided with a list of relevant application programming interfaces (APIs) for accessing tools and/or content sources of the organization.

For example, consider a user sending the following message to a chatbot interface: “What photo resolution should I use?” In such an example, the following system message (shown in italicized text) can be used to configure the second language model instance:
You're a friendly customer support chatbot.
Your primary goal is to determine the customer's needs and to get more information to use in the chat.
Rules:
1. Provide status updates after checking the order status.
2. Use knowledge_base API call to answer questions about products, services, policies, website or contact information.
3. Request order number when needed.
4. Transfer to a human when you are unable to provide an answer.
Here are the tools available to you:
knowledge_base #This API call be used to look up information about products, services, customer service contact info (phone, email, hours), policies, or website navigation.
check_order_status #This API call can provide information related to the order status, tracking numbers, and expected arrival dates.
check_order_details #This API call can give order notes and a detailed breakdown of the order contents, pricing, and shipping.
chat_summary #This API call can provide a summary of the chat, which can be used when you need to transfer the chat to a human.
Use these tools as needed to help customers with their inquiries.

It is to be appreciated that depending on the implementation, different and/or additional information can be included in the system message above (e.g., the system message can indicate constraints on when certain tools should be used or limit the data available to the second language model instance). In some examples, a request message can be generated that includes the user message and the system message. The request message can include roles to indicate a source of each of the messages (e.g., a user role can be specified for the user message and a system role can be specified for the system message).

A response message can be generated by the second language model instance that includes a knowledge_base API call to retrieve information related to the user message. For example, the knowledge_base API call can trigger a request message to be sent to the first language model instance. The request message may include the following system message to configure the first language model instance:
You will rate the relevance of each KB article on a scale of 1 to 10, where 1 is completely irrelevant and 10 is highly relevant. Here's how to categorize and rate the relevance:
*Completely Irrelevant (1)*: The article discusses a completely different topic.
Your task is to evaluate the relevance of suggested Knowledgebase (KB) articles in relation to a user's query. The website you're working with sells photo prints, personalized greeting cards, and other customizable products.
*Somewhat Relevant (2-5)*: The article only indirectly relates to the product or service in question but does not answer the query or provide specific information the user is looking for.
*Relevant (6-7)*: The article directly mentions the product or service and provides an answer, but lacks detail or clarity. The answer may be that we do not have the thing the customer is looking for.
*Highly Relevant (8-10)*: The article directly answers the specific query and provides a clear answer, even if the answer is ‘no’. An article should also be ranked in this category if it is well written, detailed, and provides a strong foundation for a highly accurate response.
You will provide your review in a simple JSON format that includes a concise version of the original query and the score for each proposed KB article. Here's an example of how your review should be formatted:

{
“concise_query”: “[the main idea from the original_query]”,
“1”: 9,
“2”: 6,
“3”: 1,
“4”: 3
}

It is noted that the JSON format in this message shown above shows the article ID of the KB entry followed by the corresponding score. For example, “1”: 9 indicates that a KB article with identifier “1” scored a 9 for the user query. It is to be appreciated that the system message can be iteratively tuned to ensure that the scoring by the first language model instance mirrors that of an expert in the subject matter. It is also to be appreciated that this is merely one example of a system message or prompt, and other prompts can also be used, such as prompts that use different scoring systems, different scoring descriptions, different descriptions, different structured formats, and/or the like.

The request message sent to the first language model can also include the original user message and entries from the KB related to the user message. For example, the results may include a set of questions and answers for commonly asked questions that are retrieved from the KB using a vector similarity search based on the user message.

The first language model then generates a response message that ranks the results of the KB entries according to the system message that was included in the request message sent to the first language model.

Another request message is sent to the second language model instance, which includes the text of the KB entries based on the rankings. For example, the text corresponding to a designated number of the highest ranked KB entries can be included in the request message. The second language model instance generates a response message that responds to the user message, which is provided to the user in the chatbot interface, for example.

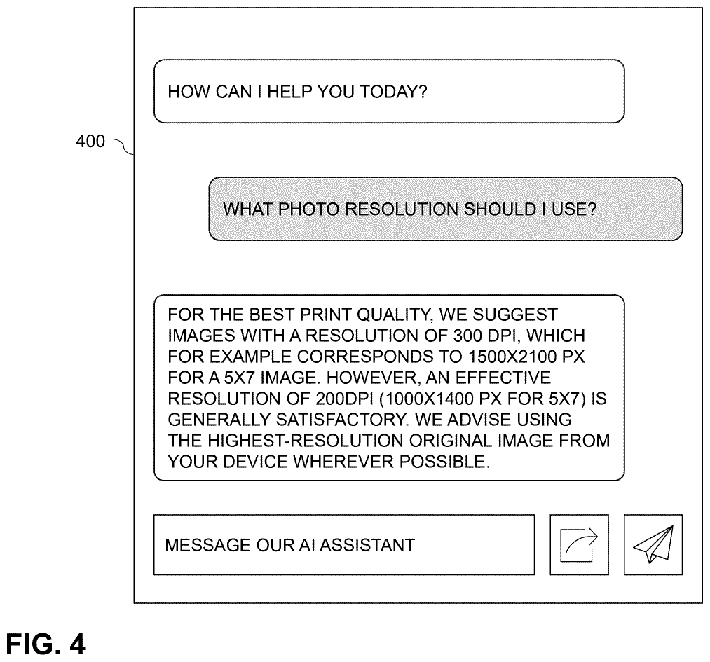

It is noted that some of the messages generated in accordance with the process in FIG. 3, can be hidden from the user, as depicted by FIG. 4. More specifically, FIG. 4 is an example of a view 400 of a client user interface, which shows messages between a chatbot (shown with no shading) and a user (shown in darker shading). The response to the query has been generated in accordance with the process depicted in FIG. 3, for example. Notably, view 400 does not include the messages, scores, prompts, and/or API calls/responses (e.g., to access the content sources) that were used to generate the response to the user.

Accordingly, at least some embodiments can provide a multi-tiered, AI-powered framework that can enhance the quality of chatbot interactions, ensuring that users receive precise, relevant, and succinct answers, while also streamlining the chatbot's access to reference material that is to be used for generating response to user queries. Such a framework is adaptable and flexible, allowing the framework to cater to different operational needs and/or allowing the framework to incorporate technological advancements. By way of example, in some embodiments, a configurable number of articles from content sources, such as KBs, can be adjusted (e.g., using a system prompt) to allow the chatbot to have access to a broader or narrower range of reference material. Also, the one or more filtering rules can be dynamically adjusted to allow the system to be more or less stringent in filtering articles, depending on the desired level of precision and the nature of the content being queried. The framework also can be configured across a wide variety of existing and future language models to ensure continuous improvement of chatbot interactions. System prompts can also be further refined over time or completely restructured to suit specific domains or industries so that responses generated by the chatbot are even more narrowly tailored to user queries. According to at least some embodiments, the system can be configured to consider additional content sources (e.g., databases, forums, or external websites), thereby broadening the scope of its utility.

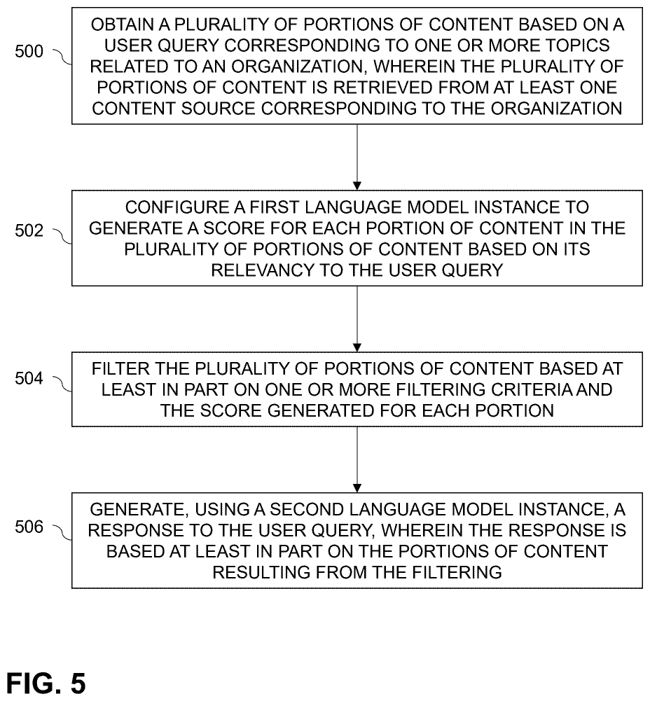

FIG. 5 is a logic flow diagram of a process for filtering content for automated user interactions using language models according to an illustrative embodiment. It is to be understood that this particular process is only an example, and additional or alternative processes can be carried out in other embodiments.

Step 500 includes obtaining a plurality of portions of content based on a user query corresponding to one or more topics related to an organization, wherein the plurality of portions of content is retrieved from at least one content source corresponding to the organization. Step 502 includes configuring a first language model to generate a score for each portion of content in the plurality of portions of content based on its relevancy to the user query. Step 504 includes filtering the plurality of portions of content based at least in part on one or more filtering criteria and the score generated for each portion. Step 506 includes generating, using a second language model instance, a response to the user query, wherein the response is based at least in part on the portions of content resulting from the filtering.

The first language model instance and the second language model instance may correspond to different machine learning models. The first language model instance may comprise a first context window and the second language model instance may comprise a second context window that is different than the first context window. The first language model instance and the second language model instance may each comprise a hyperparameter for controlling output randomness, where the hyperparameter is set to a first value for the first language model instance and the hyperparameter is set to a different, second value for the second language model instance. Each portion of the content may correspond to an article comprising text related to at least one of the one or more topics. The process may further include a step of configuring at least one of the first language model instance and the second language model instance via a system prompt, where the system prompt is hidden from a user associated with the user query. A size of the second language model instance may be larger than the first language model instance. The second language model instance and the first language model instance may have a different set of capabilities. The second language model instance may utilize more computing resources than the first language model instance. The process may further include a step of processing, using the second language model instance, the user query to identify the at least one content source from a plurality of content sources associated with the organization. The first language model instance may output the scores for the plurality of portions of content in a structured data object. The one or more filtering criteria may include at least one of: retaining a given portion of content having a score that satisfies a threshold value; and retaining a specified number of portions of content having the highest scores. The user query may be received via a chatbot interface, and the generated response may be provided to a user via the chatbot interface. The obtaining the plurality of portions of content based on the user query may include performing a vector similarity search based on the user query and content stored in the at least one content source.

Without in any way limiting the scope, interpretation, or application of the claims appearing below, a technical effect of one or more of the example embodiments disclosed herein is a chatbot system that provides improved performance by implementing a first large language model, while accurately and succinctly responding to user queries by generating responses using a second large language model. Another technical effect of one or more of the example embodiments disclosed herein is providing a scalable and adaptable chatbot system having settings that can be easily adjusted to set limits on the content used to generate automated responses to user queries. Such embodiments can effectively overcome at least some disadvantages of conventional chatbot systems, which often rely on static rules or manually-curated content to generate responses.

Embodiments herein may be implemented in software (executed by one or more processors), hardware (e.g., an ASIC), or a combination of software and hardware. In an example embodiment, the code (e.g., software code and/or an instruction set) is maintained on any one of various computer-readable media. In the context of this document, a “computer-readable medium” may be any media or means that can contain, store, communicate, propagate or transport the instructions for use by or in connection with an instruction execution system, apparatus, or device, such as the non-limiting example of the computer 102 described and depicted in FIG. 1. A computer-readable medium may comprise a computer-readable storage medium (e.g., memories 114, storage 116 or another device) that may be any media or means that can contain, store, and/or transport the software for use by or in connection with an apparatus, or device, such as a computer. Articles of manufacture comprising such computer-readable or processor-readable storage media are considered embodiments of the invention. A given such article of manufactures may comprise, for example, a storage device such as a storage disk, a storage array or an integrated circuit containing memory. It should be understood that such articles of manufacturer exclude transitory, propagating signals.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. A computer-implemented method comprising:
obtaining a plurality of portions of content based on a user query corresponding to one or more topics related to an organization, wherein the plurality of portions of content is retrieved from at least one content source corresponding to the organization;
configuring a first language model instance to generate a score for each portion of content in the plurality of portions of content based on its relevancy to the user query;
filtering the plurality of portions of content based at least in part on one or more filtering criteria and the score generated for each portion; and
generating, using a second language model instance, a response to the user query, wherein the response is based at least in part on the portions of content resulting from the filtering;
wherein the method is performed by at least one processing device comprising a processor coupled to a memory.

2. The computer-implemented method of claim 1, wherein the first language model instance and the second language model instance correspond to different machine learning models.

3. The computer-implemented method of claim 2, wherein the first language model instance comprises a first context window and the second language model instance comprises a second context window that is different than the first context window.

4. The computer-implemented method of claim 1, wherein the first language model instance and the second language model instance each comprise a hyperparameter for controlling output randomness, wherein the hyperparameter is set to a first value for the first language model instance and the hyperparameter is set to a different, second value for the second language model instance.

5. The computer-implemented method of claim 1, wherein each portion of the content corresponds to an article comprising text related to at least one of the one or more topics.

6. The computer-implemented method of claim 1, further comprising:
configuring at least one of the first language model instance and the second language model instance via a system prompt, wherein the system prompt is hidden from a user associated with the user query.

7. The computer-implemented method of claim 1, wherein at least one of:
a size of the second language model instance is larger than the first language model instance;
the second language model instance and the first language model instance have a different set of capabilities; and
the second language model instance utilizes more computing resources than the first language model instance.

8. The computer-implemented method of claim 1, further comprising:
processing, using the second language model instance, the user query to identify the at least one content source from a plurality of content sources associated with the organization.

9. The computer-implemented method of claim 1, wherein the first language model instance outputs the scores for the plurality of portions of content in a structured data object.

10. The computer-implemented method of claim 1, wherein the one or more filtering criteria comprise at least one of:
retaining a given portion of content having a score that satisfies a threshold value; and
retaining a specified number of portions of content having the highest scores.

11. The computer-implemented method of claim 1, wherein the user query is received via a chatbot interface, and the generated response is provided to a user via the chatbot interface.

12. The computer-implemented method of claim 1, wherein the obtaining the plurality of portions of content based on the user query comprises performing a vector similarity search based on the user query and content stored in the at least one content source.

13. A non-transitory processor-readable storage medium having stored therein program code of one or more software programs, wherein the program code when executed by at least one processing device causes the at least one processing device to:
obtain a plurality of portions of content based on a user query corresponding to one or more topics related to an organization, wherein the plurality of portions of content is retrieved from at least one content source corresponding to the organization;
configure a first language model instance to generate a score for each portion of content in the plurality of portions of content based on its relevancy to the user query;
filter the plurality of portions of content based at least in part on one or more filtering criteria and the score generated for each portion; and
generate, using a second language model instance, a response to the user query, wherein the response is based at least in part on the portions of content resulting from the filtering.

14. The non-transitory processor-readable storage medium of claim 13, wherein the first language model instance and the second language model instance correspond to different machine learning models.

15. The non-transitory processor-readable storage medium of claim 14, wherein the first language model instance comprises a first context window and the second language model instance comprises a second context window that is different than the first context window.

16. The non-transitory processor-readable storage medium of claim 13, wherein the first language model instance and the second language model instance each comprise a hyperparameter for controlling output randomness, wherein the hyperparameter is set to a first value for the first language model instance and the hyperparameter is set to a different, second value for the second language model instance.

17. The non-transitory processor-readable storage medium of claim 13, wherein each portion of the content corresponds to an article comprising text related to at least one of the one or more topics.

18. An apparatus comprising:
at least one processing device comprising a processor coupled to a memory;
the at least one processing device being configured:
to obtain a plurality of portions of content based on a user query corresponding to one or more topics related to an organization, wherein the plurality of portions of content is retrieved from at least one content source corresponding to the organization;
to configure a first language model instance to generate a score for each portion of content in the plurality of portions of content based on its relevancy to the user query;
to filter the plurality of portions of content based at least in part on one or more filtering criteria and the score generated for each portion; and
to generate, using a second language model instance, a response to the user query, wherein the response is based at least in part on the portions of content resulting from the filtering.

19. The apparatus of claim 18, wherein the first language model instance and the second language model instance correspond to different machine learning models.

20. The apparatus of claim 19, wherein the first language model instance comprises a first context window and the second language model instance comprises a second context window that is different than the first context window.
